(19) United States
(12) Patent Application Publication
(10) Pub. No.: US 2006/0248256 A1
(43) Pub. Date: Nov. 2, 2006

(54) Motherboard Allowing Selection of Different Central Processing Units

(76) Inventors: Ta-Wei Liu, Taipei City (TW); Wen-Chuan Hsiao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,201

(22) Filed: Jun. 13, 2005

(30) Foreign Application Priority Data
Apr. 29, 2005 (TW) 094113895

(51) Int. Cl. G06F 13/36

(52) U.S. Cl. 710/312; 710/306

(57) ABSTRACT

A motherboard includes a first CPU module including a first CPU slot and a first memory slot, a first north bridge circuit coupled to the first CPU module, a second CPU module including a second CPU slot and a second memory slot, a second north bridge circuit coupled to the second CPU module, a south bridge circuit coupled to the first north bridge circuit and the second north bridge circuit, and a selection circuit coupled to the south bridge circuit for coupling a north bridge circuit corresponding to a CPU slot containing a CPU to the south bridge circuit.

### BACKGROUND OF THE INVENTION

1. Field of the Invention

The present invention relates to a motherboard allowing selection of different central processing units, and more particularly, to a motherboard allowing use of different central processing units through the installation of a plurality of north bridge circuits corresponding to the central processing units.

2. Description of the Prior Art

A central processing unit (CPU) is one of the most important factors affecting the efficiency of a computer system. These days, the CPUs produced by Intel and Advanced Micro Device (AMD) dominate the market. However, since the Intel Pentium II entered the market, interfaces of a variety of CPUs produced by manufacturers are no longer compatible. In the years of the 486 and 586, AMD, Intel, and Cyrix chips all supported the same CPU interface (CPU slot), so it was very convenient for a user to change to a CPU of another brand.

However, these days CPUs produced by different manufacturers not only require different interfaces (slots), the chipsets functioning together with the CPUs also differ from one another even when the CPUs are produced by the same manufacturer. For example, the interfaces of CPUs produced by Intel include Socket 478, Socket 604, Socket 775, etc., and the interfaces of CPUs produced by AMD include Socket A, Socket 754, Socket 939, Socket 940, etc.

A north bridge circuit and a south bridge circuit are two core components of a conventional personal computer structure. The south bridge circuit processes input and output functions of the system (for example, data exchange between hard disks and external devices). The north bridge circuit controls high-speed communications between system processors, graphics sub-systems, memory, and peripheral component interface (PCI) buses. Since CPUs of different brands transmit differently formatted signals, the north bridge circuits for different CPUs are themselves different from one another. CPUs of different brands not only require different interfaces, their corresponding chipsets are also different. Therefore, if the CPU is changed, the motherboard has to be changed accordingly. This wastes resource and increases the burden on consumers.

### SUMMARY OF THE INVENTION

It is therefore a primary objective of the claimed invention to provide a motherboard allowing selection of different central processing units.

The motherboard includes a first CPU module comprising a first CPU slot and a first memory slot, a first north bridge circuit coupled to the first CPU module, a second CPU module comprising a second CPU slot and a second memory slot, a second north bridge circuit coupled to the second CPU module, a south bridge circuit coupled to the first north bridge circuit and the second north bridge circuit, and a selection circuit coupled to the south bridge for coupling the south bridge circuit either to the first north bridge circuit when a CPU is inserted into the first CPU slot of the first CPU module, or to the second north bridge circuit when a CPU is inserted into the second CPU slot of the second CPU module.

The present invention further discloses a motherboard, which includes a first CPU module comprising a first CPU slot and a first memory slot, a first north bridge circuit coupled to the first CPU module, an interface circuit for insertion of a CPU interface card, a south bridge circuit coupled to the first north bridge circuit and the interface circuit, and a selection circuit coupled to the south bridge for coupling the south bridge circuit to either of the first north bridge circuit and the interface circuit according to signals of the interface circuit and the first north bridge circuit.

The present invention further discloses a motherboard, which includes an interface circuit for engaging with a CPU interface card, and a south bridge circuit coupled to the interface circuit.

Through the use of the motherboards of the present invention, a user can select different CPUs according to the CPU interface cards, and hereby achieve the object to install a variety of CPUs on an identical motherboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a motherboard allowing selection of different central processing units of a first embodiment according to the present invention.

FIG. 2 is a block diagram of a motherboard allowing selection of different central processing units of a second embodiment according to the present invention.

FIG. 3 is a block diagram of a motherboard allowing selection of different central processing units of a third embodiment according to the present invention.

### DETAILED DESCRIPTION

In a computer system, a south bridge circuit processes input and output functions of the system (for example data exchange between hard disks, external devices), and a north bridge circuit controls high-speed communications between system processors, graphics sub-systems, memory, and peripheral component interface (PCI) buses. Thus, north bridge circuits for use with different CPUs differ from one another, while south bridge circuits can be the same. The present invention provides, in an identical platform (motherboard), a south bridge circuit and a variety of north bridge circuits corresponding to different CPUs, so as to achieve the object of allowing installation of different central processing units.

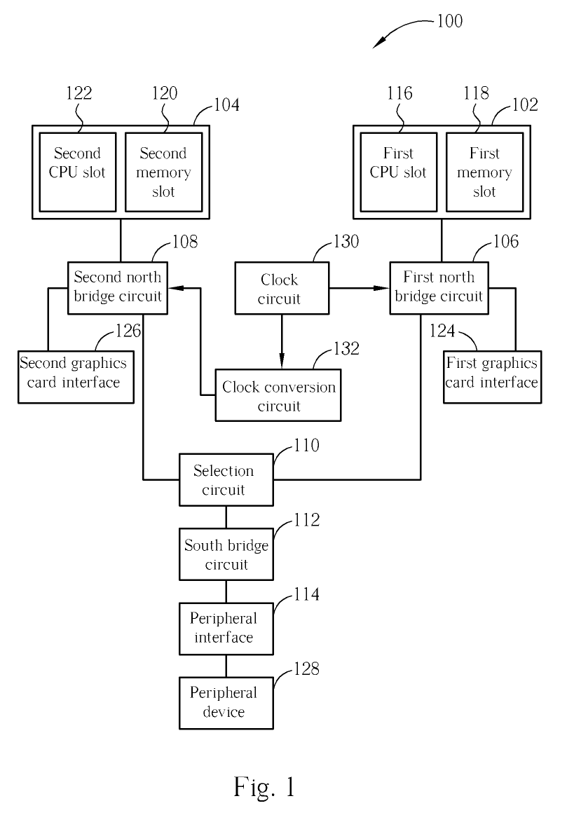

Please refer to FIG. 1, which is a block diagram of a motherboard 100 allowing selection of different central processing units of a first embodiment according to the present invention. The motherboard 100 comprises a first CPU module 102, a second CPU module 104, a first north bridge circuit 106, a second north bridge circuit 108, a selection circuit 110, a south bridge circuit 112, a first graphics card interface 124, a second graphics card interface 126, a peripheral interface 114, a clock circuit 130, a clock conversion circuit 132, and a peripheral device 128. The first CPU module 102 comprises a first CPU slot 116 and a first memory slot 118. The second CPU module 104 comprises a second CPU slot 122 and a second memory slot 120. The first CPU slot 116 has a type different from that of the second CPU slot 122, both of which are installed to receive CPUs of different interfaces and their corresponding memories. The first north bridge circuit 106 functions together with the first CPU module 102, to execute data exchange between system processors, graphics sub-systems, memory, and peripheral component interconnect buses, and transmit video data via the first graphics card interface 124 to a graphics card (not shown in FIG. 1). Similarly, the second north bridge circuit 108 functions together with the second CPU module 104, to execute data exchange between system processors, graphics sub-systems, memory, and peripheral component interconnect buses, and transmit video data via the second graphics card interface 126 to another graphics card (not shown in FIG. 1). The south bridge circuit 112 processes signal exchange between the motherboard 100 and the peripheral device 128 through the use of the peripheral interface 114. The peripheral interface 114 can be a hard disk bus, a PCI-E bus, an expansion interface(for example an IEEE 1394 slot or a USB slot), or a network interface. Therefore, hard disks, network cards, sound cards, and external devices can exchange data with the motherboard 100 via south bridge circuit 112. Note that in FIG. 1 the first north bridge circuit 106 and the second north bridge circuit 108 are coupled via the selection circuit 110 to the south bridge circuit 112. The selection circuit 110 couples the first north bridge circuit 106 to the south bridge circuit 112 when a CPU is inserted into the first CPU slot 116, and the computer system executes corresponding functions with the first CPU module 102, the first north bridge circuit 106, and the south bridge circuit 112; or couples the second north bridge circuit 108 to the south bridge circuit 112 when a CPU is inserted into the second CPU slot 122, and the computer system executes corresponding functions with the second CPU module 104, the second north bridge circuit 108, and the south bridge circuit 112.

Moreover, in FIG. 1 the clock circuit 130 is capable of outputting clock signals to the first north bridge circuit 106, and outputting converted clock signals corresponding to the second north bridge circuit 108 to the second north bridge circuit 108 with the clock conversion circuit 132. Therefore, the motherboard 100, even comprising only one clock circuit, can function together with different central processing units.

Through the use of the motherboard 100 of the present invention, a user can change CPUs corresponding to the first and second CPU modules 102 and 104, without changing the motherboard. Further, as long as a CPU module and a north bridge module are integrated into an identical CPU interface card, central processing units can be changed by plugging in cards.

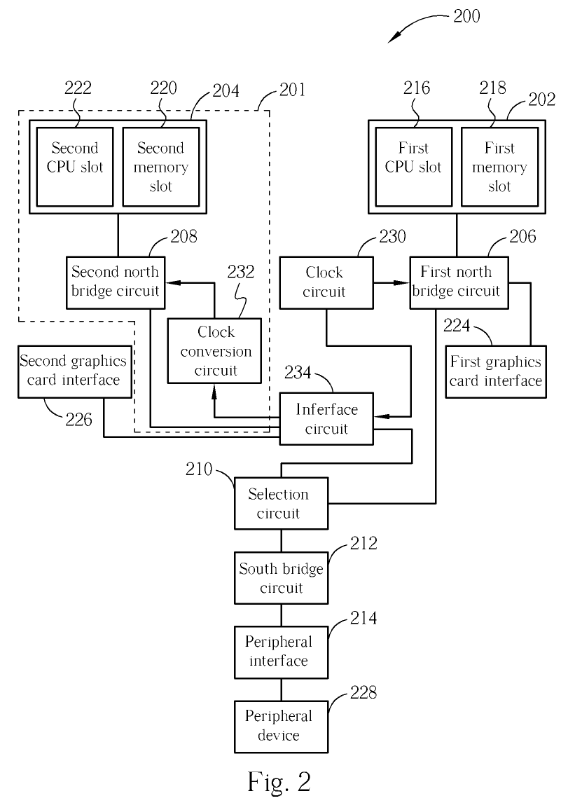

Please refer to FIG. 2, which is a block diagram of a motherboard 200 allowing selection of different central processing units of a second embodiment according to the present invention. The motherboard 200 comprises an interface circuit 234, a first CPU module 202, a first north bridge circuit 206, a selection circuit 210, a south bridge circuit 212, a first graphics card interface 224, a second graphics card interface 226, a clock circuit 230, and a peripheral device 228. Additionally, the motherboard 200 can be combined with a CPU interface card 201 through the use of the interface circuit 234 to accommodate different central processing units. The CPU interface card 201 comprises a second CPU module 204, a second north bridge circuit 208 and a clock conversion circuit 232. The operation of the motherboard 200 shown in FIG. 2 is similar to the operation of the motherboard 100 shown in FIG. 1. The first CPU module 202 comprises a first CPU slot 216 and a first memory slot 218. The second CPU module 204 comprises a second CPU slot 222 and a second memory slot 220. The first CPU slot 216 has a type different from that of the second CPU slot 222, both of which have CPUs of different interfaces and their corresponding memories. After a CPU and a memory are inserted into the second CPU slot 222 and the memory slot 220 respectively, a user can combine the CPU interface card 201 with the interface circuit 234. Then, the selection circuit 210 couples the south bridge circuit 212 to the interface circuit 234 and blocks signals between the south bridge circuit 212 and the first north bridge circuit 206. Therefore, through the second CPU slot 222, the second memory slot 220, the second north bridge circuit 208, and the clock conversion circuit 232, the motherboard 200 can execute corresponding functions of the system. Note that the second north bridge circuit 208 outputs video signals via the interface circuit 234 to the second graphics card interface 226, and converts the clock signals output by the clock circuit 230 into proper clock signals with the clock conversion circuit 232 and the interface circuit 234.

In FIG. 2, the motherboard 200 is pre-installed with the first CPU slot 216, which is of a specific format. If the interface format of a CPU does not correspond to the first CPU slot 216, a user can select a CPU interface card 201 complying with the specific format, and insert the CPU into the second CPU slot 222 through the CPU interface card 201 so as to form a complete computer system. That is to say, without changing the motherboard 200, the user can select, depending on their specific need, a proper CPU interface card to realize the objective of using an identical motherboard to accommodate different central processing units.

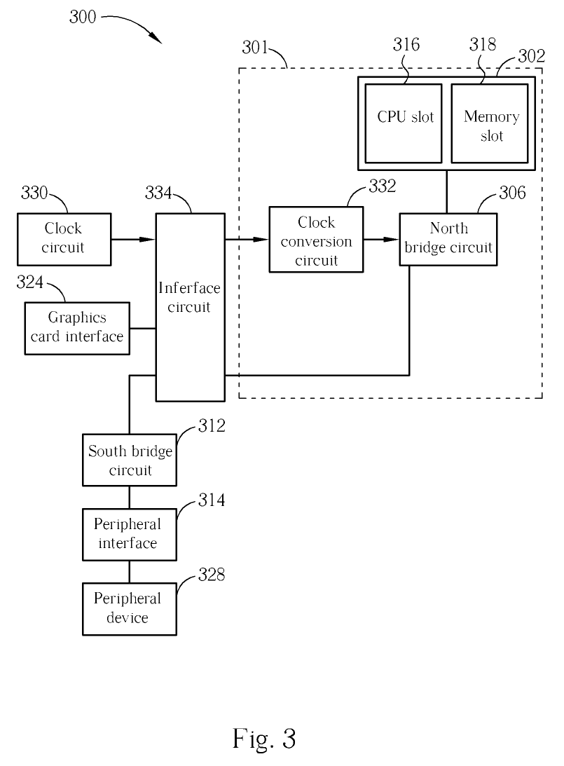

Please refer to FIG. 3, which is a block diagram of a motherboard 300 allowing selection of different central processing units of a third embodiment according to the present invention. The motherboard 300 comprises an interface circuit 334, a south bridge circuit 312, a graphics card interface 324, a clock circuit 330, and a peripheral device 328. The motherboard 300 allows selection of different central processing units through the engagement of the interface circuit 334 and a CPU interface card. The CPU interface card 301 comprises a CPU module 302, a north bridge circuit 306, and a clock conversion circuit 332. In contrast to motherboards shown in FIG. 2 and FIG. 3, the motherboard 300 shown in FIG. 3 does not comprise a pre-installed CPU module. When a user plans to install a CPU of a specific interface on the motherboard 300, the user can select the CPU interface card 301 complying with the specific interface, and engage the interface circuit 334 to the CPU interface card 301, which comprises the CPU the memory. Therefore, the motherboard 300 can function normally. In normal conditions, if a user plans to change a CPU with different interfaces, the user does not have to change the motherboard, but instead only the CPU interface card. Therefore, through changing of a CPU interface card, the motherboard 300 can realize selection of different central processing units.

The above CPU interface card and graphics card interface are not limited to specific interface formats, as long as they can realize the object of the present invention. For example, the CPU interface card and the graphics card interface of the present invention can be of an interface format complying with a peripheral component interconnect-express (PCI-E) standard. Through the use of the motherboard of the present invention, a user can change, depending on their needs, different CPUs by plugging cards into the motherboard, so as to achieve the objective of installing a variety of CPUs on an identical motherboard. This reduces resource consumption and makes changing CPUs more convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motherboard comprising:
a first CPU module comprising a first CPU slot and a first memory slot;
a first north bridge circuit coupled to the first CPU module;
a second CPU module comprising a second CPU slot and a second memory slot;
a second north bridge circuit coupled to the second CPU module;
a south bridge circuit coupled to the first north bridge circuit and the second north bridge circuit; and
a switch circuit coupled to the south bridge for coupling the south bridge circuit either to the first north bridge circuit when a CPU is inserted into the first CPU slot of the first CPU module, or to the second north bridge circuit when a CPU is inserted into the second CPU slot of the second CPU module.

2. The motherboard of claim 1, wherein the north bridge circuit is further coupled to a graphics card interface for insertion of a graphics card.

3. The motherboard of claim 2, wherein the graphics card interface is a peripheral component interconnect-express (PCI-E) interface.

4. The motherboard of claim 1 further comprising a clock circuit for providing clock signals to the first north bridge circuit.

5. The motherboard of claim 4 further comprising a clock conversion circuit coupled to the clock circuit and the second north bridge circuit for converting the clock signals into converted clock signals corresponding to the second CPU module.

6. The motherboard of claim 1, wherein the first CPU slot is of a type different from that of the second CPU slot.

7. The motherboard of claim 1, wherein the south bridge circuit is further coupled to a peripheral interface for exchanging data with a peripheral device.

8. A motherboard comprising:
a first CPU module comprising a first CPU slot and a first memory slot;
a first north bridge circuit coupled to the first CPU module;
an interface circuit for insertion of a CPU interface card;
a south bridge circuit coupled to the first north bridge circuit and the interface circuit; and
a switch circuit coupled to the south bridge for coupling the south bridge circuit to either of the first north bridge circuit and the interface circuit according to signals of the interface circuit and the first north bridge circuit.

9. The motherboard of claim 8, wherein the CPU interface card comprises:
a second CPU module comprising a second CPU slot and a second memory slot; and
a second north bridge circuit coupled to the second CPU module.

10. The motherboard of claim 8, wherein the north bridge circuit is further coupled to a graphics card interface for insertion of a graphics card.

11. The motherboard of claim 8 further comprising a clock circuit for providing clock signals to the first north bridge circuit.

12. The motherboard of claim 11 further comprising a clock conversion circuit coupled to the interface circuit and the second north bridge circuit for converting the clock signals output from the clock circuit into converted clock signals corresponding to the second CPU module.

13. The motherboard of claim 8, wherein the first CPU slot is of a type different from that of the second CPU slot.

14. The motherboard of claim 8, wherein the south bridge circuit is further coupled to a peripheral interface for exchanging data with a peripheral device.

15. A motherboard comprising:
an interface circuit for engaging with a CPU interface card; and
a south bridge circuit coupled to the interface circuit.

16. The motherboard of claim 15, wherein the CPU interface card comprises:
a CPU module comprising a CPU slot and a memory slot; and
a north bridge circuit coupled to the CPU module.

17. The motherboard of claim 16, wherein the CPU interface card further comprises a clock conversion circuit coupled to the interface circuit and the north bridge circuit for converting clock signals.

18. The motherboard of claim 15, wherein the interface is further coupled to a graphics card interface for insertion of a graphics card.

19. The motherboard of claim 15 further comprising a clock circuit for providing clock signals to the interface circuit.

20. The motherboard of claim 15, wherein the south bridge circuit is further coupled to a peripheral interface for exchanging data with a peripheral device.
